(19) United States
(12) Patent Application Publication
(10) Pub. No.: US 2021/0248458 A1
(43) Pub. Date: Aug. 12, 2021

(54) ACTIVE LEARNING FOR ATTRIBUTE GRAPHS

(71) Applicants: Florence ROBERT-RÉGOL, Montreal (CA); Yingxue ZHANG, Montreal (CA); Mark COATES, Montreal (CA)

(72) Inventors: Florence ROBERT-RÉGOL, Montreal (CA); Yingxue ZHANG, Montreal (CA); Mark COATES, Montreal (CA)

(21) Appl. No.: 16/785,477

(22) Filed: Feb. 7, 2020

(51) Int. Cl. G06N 3/08; G06F 16/901; G06N 3/04

(52) U.S. Cl. CPC G06N 3/08; G06N 3/0427; G06F 16/9024

(57) ABSTRACT

Method and system for processing an attributed graph that comprises a training dataset of labelled nodes and an unlabeled dataset of unlabeled nodes. The method and system includes selecting, using logistic regression, which candidate node from a plurality of possible candidate nodes included in the unlabeled dataset will minimize a risk if that candidate node is added to the training dataset; obtaining a label for the selected candidate node from a classification resource; and adding the selected candidate node and the obtained label to the training dataset as a labelled node to provide an enhanced training dataset.

### RELATED APPLICATIONS

None

### FIELD

This disclosure relates generally to the processing of graphs, and more particularly active learning applied to the processing of graphs.

### BACKGROUND

A graph is a data structure that comprises nodes and edges. Each node represents an instance or data point that is defined by measured data represented as a set of node features (e.g., a multidimensional feature vector). Each edge represents a relationship that connects two nodes.

Processing graphs using machine learning based systems is of growing interest due to the ability of graphs to represent objects and their inter-relationships across a number of areas including, among other things, social networks, financial networks, and physical systems. Machine learning based systems are, for example, being developed for graph analysis tasks including node classification, link prediction, sub-graph classification and clustering.

Generally, machine learning algorithms are used to learn a mapping function that can map inputs to desired outputs.

In supervised learning, the machine learning algorithm has access to a training dataset of input-output pairs such that the algorithm knows what the desired output is for each input. In unsupervised learning, the training dataset includes only inputs with no corresponding outputs. In semi-supervised learning, the training dataset includes a combination of input-output pairs and input-only inputs. In many machine learning scenarios, the training dataset is fixed and does not change.

Active learning is a further variation of machine learning in which the training dataset isn't fixed. For example, in an active learning scenario applied to a semi-supervised training dataset that includes both input-output pairs and input-only inputs, the machine learning algorithm can request an external adviser (e.g., an oracle) to provide a high trust output for an input-only input, thus converting input-only input into a input-output pair and thereby increasing the number of input-out pairs in in the training set. Generally there will be a cost associated with consulting the oracle, and accordingly an efficient active learning algorithm will try to judiciously select which inputs would be the most helpful to know the outputs for and thereby limit the number of inputs that the oracle is requested to provide outputs for. For example, a medical setting may include medical devices that can output thousands of medical images, but an output of interest (e.g., label=cancerous or label=healthy) requires the expertise of a medical expert. In that situation, the training dataset can include an unsupervised training dataset of images without labels (e.g., input-only inputs) and a supervised set of images that have been previously labeled (e.g., input-output pairs) by a medical expert (e.g. radiologist). In an active learning scenario, the machine learning algorithm includes a mechanism to selectively request an oracle (e.g., radiologist) to provide a high trust label to an image from the unsupervised training dataset, thereby adding another input-output pair to the supervised training dataset. In such a setting, the oracle radiologist is a time limited and costly resource, so the consulting mechanism of the machine learning algorithm should be configured to limit output requests to inputs where they will be of high benefit to learning the mapping function during training. In many applications which utilize active learning, a human plays the role of oracle (e.g., human-in-the-loop) during training, however in some applications which utilize active learning the oracle could be automated—for example the oracle could be a computer based resource that has access to faster computing power, more memory, more powerful machine learning resources and/or more powerful or specialized mapping functions than the resource hosting the machine learning algorithm that makes the request.

One of the main applications of machine learning is classification which involves identifying which category from a set of categories a new input belongs to. The set of categories is called classes, and the specific class identified (e.g. the output) for an input is called a label.

As noted above, in a graph, data is structured as nodes that encode data points and edges that encode relationship information between the data points. A machine learning algorithm can leverage the relationship information to improve classification performance by looking at the connections of a node. A semi-supervised graph training dataset will typically include a subset of labelled ground truth nodes (hereinafter labelled nodes) for supervised training, a much larger number of unlabeled nodes, and connection data defining the graph structure. A machine learning algorithm that processes the graph and, based on the labeled nodes and the connection data, learns a mapping function for mapping the unlabeled nodes to respective labels. In the case of active learning, a machine learning algorithm can request a classification resource (e.g., an oracle) to provide a high trust or ground truth label for a number of unlabeled nodes.

Identifying the unlabeled nodes that should be referred to the classification resource (e.g., the oracle) for labelling is a challenge faced in active learning. In the case of graph processing, this involves identifying specific unlabeled nodes in a semi-supervised training dataset that should be referred to the classification resource (e.g., the oracle) in order to optimize mapping function learning process.

In the case of attributed graphs, deep learning artificial neural networks, including Graph Convolutional Neural Networks (GCNNs) have been proposed for active graph learning. Graph Convolutional Neural Networks (GCNN) incorporate the graph topology in the learning process by aggregating the features of a node with features from its neighborhood. Active learning uses the output of the GCNN to derive active learning metrics. In one known solution, GCNN training alternates between adding one node to the supervised training dataset and performing one epoch of training. Selection of the query node is based on a score that is a weighted mixture of metrics. Some solutions further add the use of a multi-armed bandit algorithm that learns how to balance the contributions of the different metrics to adapt to the varying natures of different datasets.

Deep learning methods require a large number of labelled nodes at the start of active learning. Increasing the number of labelled nodes for training is the main motivation for using active learning. However, known deep learning methods face constraints as the cost of acquiring labels from a classification resource (e.g., an oracle) can be prohibitively expensive and thus limit the amount of labelled nodes required to optimally learn a mapping function.

Accordingly, there is a need for active learning methods and systems that will enable efficiently select unlabeled nodes for labelling.

### SUMMARY

According to aspect of the present disclosure, there is provided a method for processing an attributed graph that comprises a training dataset of labelled nodes and an unlabeled dataset of unlabeled nodes. The method comprises: selecting, using logistic regression, which candidate node from a plurality of possible candidate nodes included in the unlabeled dataset will minimize a risk if that candidate node is added to the training dataset; obtaining a label for the selected candidate node from a classification resource; and adding the selected candidate node and the obtained label to the training dataset as a labelled node to provide an enhanced training dataset.

In accordance with the preceding aspect, the selecting, obtaining and adding are repeated a predefined number of times to add a corresponding number of labelled candidate nodes to the training data set.

In accordance with any of the preceding aspects, the method further includes learning, using the attributed graph including the enhanced training dataset, a prediction function to predict labels for the unlabeled nodes in the unlabeled dataset. In accordance with any of the preceding aspects, the prediction function is a regression function learned using a respective logistic regression algorithm.

In accordance with any of the preceding aspects, selecting the candidate node comprises: determining, for each of the plurality of possible candidate nodes, a respective risk value, the selected candidate node being the candidate node having the lowest respective risk value.

In accordance with any of the preceding aspects, determining the respective risk value for each of the possible candidate node comprises: for each candidate node candidate node, predicting for each possible label from a set of k candidate labels, the label distribution of the other possible candidate nodes if the candidate node is added to the training set with that label. In some examples, predicting the label distribution in respect of the candidate node added to the training set with the label is performed by training a logistic regression algorithm to learn a respective regression function that outputs the predicted label distribution.

In accordance with any of the preceding aspects, obtaining the label for the selected candidate node comprises providing a label query for the selected candidate node to the classification resource, wherein the classification resource includes an interface for presenting information about the selected candidate node to, and receiving a labelling input, from a human.

In accordance with any of the preceding aspects, obtaining the label for the selected candidate node comprises providing a label query for the selected candidate node to the classification resource, wherein the classification resource is an automated system.

In accordance with any of the preceding aspects, the logistic regression approximates a graph convolution neural network process.

According to further aspect of the present disclosure, there is provided a system for processing an attributed graph that comprises a training dataset of labelled nodes and an unlabeled dataset of unlabeled nodes. The system comprises an active learning module that is configured to provide an enhanced training dataset by: selecting, using logistic regression, which candidate node from a plurality of possible candidate nodes included in the unlabeled dataset will minimize a risk if that candidate node is added to the training dataset; obtaining a label for the selected candidate node from a classification resource; and adding the selected candidate node and the obtained label to the training dataset as a labelled node to provide an enhanced training dataset. In accordance with any preceding aspects, the active learning module is configured to repeat the selecting, obtaining and adding a predefined number of times to add a corresponding number of labelled candidate nodes to the training data set.

In accordance with any preceding aspects, the system also includes a prediction module that is configured to learn, using the attributed graph including the enhanced training dataset, a prediction function to predict labels for the unlabeled nodes in the unlabeled dataset. In some examples, the prediction function is a regression function learned using a respective logistic regression algorithm.

In accordance with any of the preceding aspects, the classification resource includes an interface for presenting information about the selected candidate node to, and receiving a labelling input, from a human. In some examples, the classification resource is an automated system having labelling capabilities that are more trusted than those of the learning module.

### BRIEF DESCRIPTION OF THE DRAWINGS

Reference will now be made, by way of example, to the accompanying drawings which show example embodiments of the present application, and in which:

FIG. 1 is a block diagram illustrating an example of an active learning graph processing system accordingly to example embodiments;

FIG. 2 is a flow diagram showing an operation of an active learning module of the graph processing system of FIG. 1; and

FIG. 3 is a block diagram illustrating an example processing system that may be used to execute machine readable instructions to implement the graph processing system of FIG. 1.

Similar reference numerals may have been used in different figures to denote similar components.

### DESCRIPTION OF EXAMPLE EMBODIMENTS

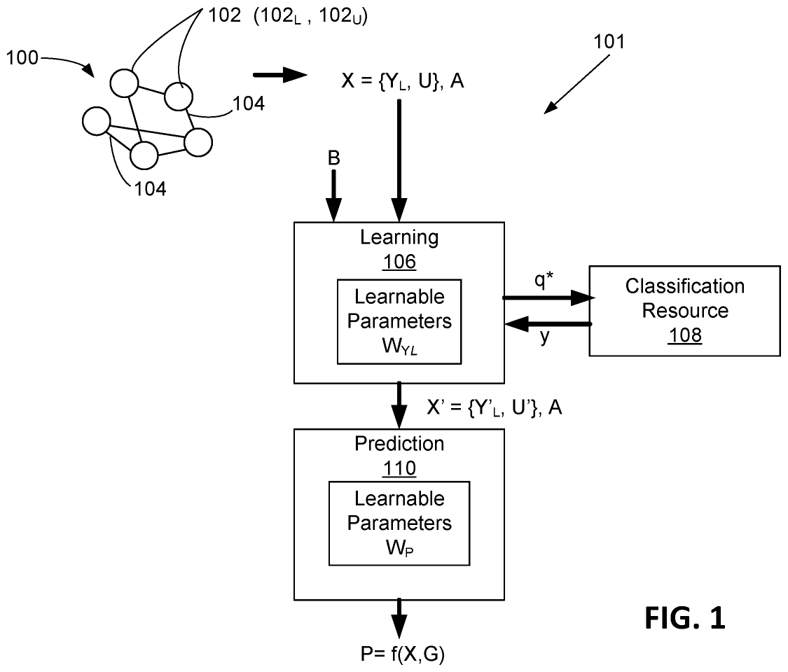

FIG. 1 illustrates an example of an attributed graph 100 and a graph processing system 101 for processing the graph 100, according to example embodiments. Graph 100 is a data structure for representing a dataset as nodes 102 and connecting edges 104. Each node 102 represents an instance or data point that represents measured data and is defined by a set of node attributes that are quantified as features (e.g., a multidimensional feature vector x). Nodes 102 include a training dataset Y_{L} of labelled nodes 102_{L} for supervised training. Labelled nodes 102_{L} each have a known classification label y. Each label y belongs to a set of K possible node classification labels. Nodes 102 also include an unlabeled dataset U of unlabeled nodes 102_{U} (e.g. nodes that are as-yet unclassified). Unlabeled nodes 102_{U} will typically greatly outnumber labelled nodes 102. Each edge 104 represents a relationship that connects two nodes.

The node feature vectors for all the nodes 102 are collectively defined in a features matrix X. Features matrix X includes a set of feature vectors that each represent respective labelled nodes 102_{L} of training dataset Y_{L}. The feature vectors for these training nodes 102_{L} each specify or are associated with a respective target variable (i.e., node label y). Features matrix X also includes a set feature vectors that each represent respective unlabeled nodes 102_{U} of unlabeled node set U. The topology of graph 100 is represented in an adjacency matrix A that defines the connections (edges 104) between the nodes 102. In some example embodiments where N is the number of nodes 102, the adjacency matrix A is an N×N matrix of binary values that indicate the presence or absence of a connection between each respective pair of nodes 102 in the graph 100. In some examples, the edges may be weighted and in which case the adjacency matrix A matrix may be populated with weight values indicating a relationship strength.

Graph processing system 101 is an active machine learning system structured to process graph 100 to output respective labels y for unlabeled nodes 102_{U}. In example embodiments, graph processing system 101 includes a logistic regression based active learning module 106 for actively learning labels y for selected unlabeled nodes 102_{U} represented in unlabeled set U. As will be described below, active learning module 106 includes a logistic regression algorithm that learns a regression function that is defined by learnable parameters (e.g., weights W_{YL}). The set of newly labelled nodes are then combined with previously labelled nodes 102_{L} to provide an enhanced supervised training set Y′_{L} as part of an enhanced features matrix X′. In example embodiments, graph processing system 101 also includes a logistic regression based prediction module 110 that is structured to process graph 100 based on the enhanced features matrix X′ to predict labels for the feature vectors U′ that correspond to the remaining unlabeled nodes 102_{U}. Prediction module 110 also includes implements a logistic regression algorithm to learn a regression function that is defined by a set of learnable parameters (e.g. weights W_{P}).

In order to perform active learning, learning module 106 is configured to select nodes 102_{U} that are represented in the unlabeled node set U for referral to a classification resource 108 (e.g., an oracle) for labelling. This is illustrated in FIG. 1, where q* represents a query node sent by learning module 106 for labelling, and y represents the corresponding label applied by the classification resource 108 in response. In example embodiments, classification resource 108 is a resource that has labelling capabilities that are different (e.g., more trusted or have ground truth labelling capability) than those of learning module 106 and prediction module 110. In some examples, classification resource 108 may include an expert resource that is more costly, on a per classification basis, than learning module 106 and prediction module 110. For example, classification resource 108 may include an expert human-in-the-loop to deduce labels. In such cases, the classification resource 108 includes a user interface for interacting with the expert human, and in particular to present the human with information about data instance represented by the query node q* and receive labelling input for the query node q* from the human. In some examples, classification resource 108 may not require a human classifier but rather be implemented by an automated system that uses and/or has access to more information and/or more computational resources than learning module 106 and prediction module 110.

In example embodiments, learning module 106 is constrained by a budget B that defines a maximum number of unlabeled nodes 102_{U} for which respective queries can be made to classification resource 108 during a training session. In some examples, the number set for query budget B is a predetermined constraint. In some examples, the number set for query budget B may be a hyper-parameter. In example embodiments learning module 106 is configured to identify what B nodes of the unlabeled nodes 102_{U} within the graph 100 will, if labelled, most likely result in an enhanced supervised training data set Y′_{L} that optimizes the performance of prediction module 110.

In example embodiments, in order to select unlabeled nodes 102_{U} for referral to classification resource 108, learning module 106 is configured to iteratively select B unlabeled nodes 102_{U} based on an expected error minimization (EEM) objective. The objective of EEM is to minimize expected classification errors that will occur after an unlabeled node 102_{U} is added to the training dataset Y_{L}. In example embodiments, learning module 106 predicts a risk value R_{|Y}_{_{L}}^{+q} that measures the risk of adding a candidate node q to the training dataset Y_{L}. Once the risk value R_{|Y}_{_{L}}^{+q} has been predicted for each unlabeled node 102_{U}, the unlabeled node 102_{U} with the smallest risk value R_{|Y}_{_{L}}^{+q} is selected as a query node q* and provided to classification resource 108. The newly labelled node q* is then added to the labelled training dataset Y_{L}. This process is repeated B times, resulting in enhanced training subset Y′_{L}.

In an example embodiment, the risk value R_{|Y}_{_{L}}^{+q} for a candidate node q can be defined by equation (1):

$${R}_{\vert {Y}_{L}}^{+ q} {=}^{Δ} {E}_{ya} [ {E}_{{Y}_{U} - q} [ \frac{1}{\vert {U}^{- q} \vert} {\sum }_{i = 0}^{{U}^{\cdot q}} [ {\hat{y}}_{i} \neq yi \vert {y}_{q} {Y}_{L} ] ] \qquad ( EQ . 1 )$$

In example embodiments, the learning module 106 is configured to predict, for each candidate node q for each possible class k, what the label distribution would be for all the other unlabeled nodes 102uᵢ (where i∈U^{-q}) remaining in the unlabeled node set U if that candidate node q were added to the training dataset Y_{L} with a label yₖ. Accordingly, the risk value R_{|Y}_{_{L}}^{+q} for a candidate node q can be determined according to the following equation (2):

$${R}_{\vert {Y}_{L}}^{+ q} = \frac{1}{\vert {U}^{- q} \vert} {\sum }_{k ϵ K} {\sum }_{i ϵ {U}^{- q}} ( 1 - {max}_{{k}^{′} ∈ K} p ( yi = {k}^{′} \vert {Y}_{L , {y}_{q}} = k ) ) p ( {y}_{q} = k \vert {Y}_{L} ) \qquad ( EQ . 2 )$$

As indicated in equation 2, the predicted label for each node i is given by the probability function p(yᵢ=k|Y_{L}). Rather than use a conventional GCNN to predict probability distributions in respect of each candidate node q, learning module 106 utilizes a less computationally intensive graph-cognizant logistic regression algorithm that learns a regression function to approximate a probability distribution, In example embodiments, the logistic regression algorithm applied by the learning module 106 functions as a simplified version of a GCNN. An example of a logistic regression algorithm that simplifies a GCNN is described in: F. Wu, A. Souza, T. Zhang, C. Fifty, T. Yu, and K. Weinberger, “Simplifying graph convolutional networks,” in Proc. Int. Conf. Machine Learning, Long Beach, Calif., USA, June 2019, pp. 6861-6871 (incorporated herein by reference)

In particular, to compute probability function p(y=k|Y_{L}), learning module 106 applies the 1=layered graph-cognizant logistic regression function represented by equation (3):

Ŷ_{L}=σ(\tilde{X}W_{Y}_{_{L}}) (Eq. 3)

Where: \tilde{X}_{L}=Â^{l}X are graph preprocessed features computed before each of the B node query iterations; W_{Y}_{_{L}} are learnable weights of the logistic regression function; and σ is a softmax operator.

As per equation (3), the current known labels Y_{L} can be used to determine regression weights W_{Y}_{_{L}}, which can then be used in the calculation:

p(y_{q}=k|Y_{L})=σ(\tilde{x}_{L}W_{Y}_{_{L}})^{(k)} (Eq. 4)

where: k is an index that indicates that the kth element of the vector be extracted, and logistic regression function.

For each candidate node q, for each possible class k, the following is solved:

Ŷ_{L,+q,y}_{ₖ}=σ(\tilde{X}_{L,+q,y}_{ₖ}W_{+q,y}_{ₖ}) (Eq. 5)

where: +q, yₖ indicates the addition of candidate node q with assigned label yₖ to the labelled training dataset Y_{L}.

The class for a particular unlabeled node i∈U^{-q} (where q represents removal of the candidate node from the unlabeled dataset U) can be determined by (equation 6):

p(yᵢ=k′|Y_{L,y}_{_{q}}₌ₖ)=σ(\tilde{x}ᵢW_{+q,y}_{ₖ})^{(k)} (Eq. 6)

Substituting equation (6) into equation (2) gives the complete regression function for predicting risk value R_{|Y}_{_{L}}^{+q}, which can be solved using default parameters from logistic regression libraries as follows:

$${R}_{\vert {Y}_{L}}^{+ q} = {\sum }_{k ϵ K} \frac{1}{\vert {U}^{- q} \vert} {\sum }_{i = 0} ( 1 - {max}_{{k}^{′} ∈ K} {σ ( {\tilde{x}}_{i} {W}_{+ q , {y}_{k}} )}^{( {k}^{′} )} {σ ( {\tilde{x}}_{q} {W}_{{Y}_{L}} )}^{( k )} \qquad EQ . ( 7 )$$

The unlabeled node that minimizes the risk value R_{|Y}_{_{L}}^{+q} can be identified as the query node q* as follows:

$$q *= {arg min}_{q} {R}_{\vert {Y}_{L}}^{+ q} \qquad EQ . ( 8 )$$

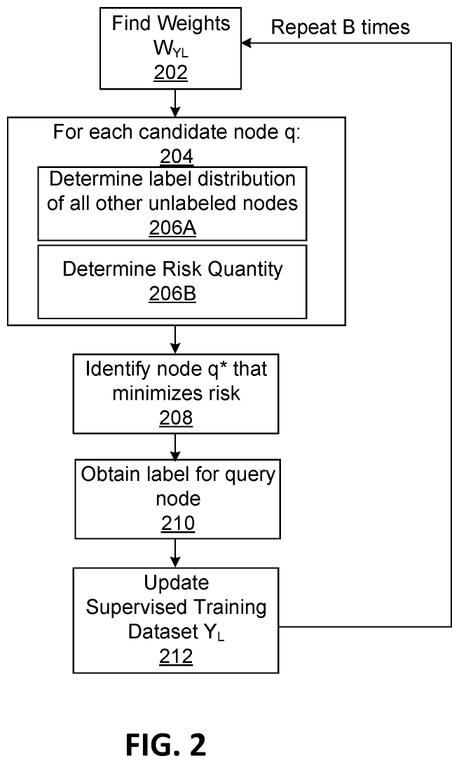

To summarize, FIG. 2 is a flow diagram illustrating operation of active learning module 106 according to example embodiments. As indicated in block 202, at the start of each query iteration, the existing training dataset Y_{L} is used to determine an initial set of regression weights W_{YL} based on the relationship shown in equation (3). Then, as indicated in block 204, for each candidate node q∈U: (1) for each possible class k, the active learning module 106 learns a regression function to predict what the label distribution for all of the other unlabeled nodes 102_{Ui} (i∈U^{-q}) would be if the candidate node q were added to the training dataset Y_{L} with label yₖ (block 206A); and (2) the risk value R_{|Y}_{_{L}}^{+q} is determined for the candidate node q (block 206B). The candidate nodes include all unlabeled nodes 102_{U}, and accordingly the actions represented in blocks 206A, 206B are repeated until the risk value R_{|Y}_{_{L}}^{+q} is calculated for all of the unlabeled nodes included in the unlabeled node set U at the time the actions of block 204 are performed.

Once a respective risk value R_{|Y}_{_{L}}^{+q} is determined for all candidate nodes 102_{U}, as indicated in block 208, the unlabeled node that has the lowest risk value R_{|Y}_{_{L}}^{+q} is identified as the query node q*. As indicated in block 210, the learning module 106 obtains a label y for the query node q* from classification resource 108 by submitting a query in respect of the unlabeled node to the classification resource 108. The active learning module 106 then updates the graph node dataset features matrix X by adding the query node q* with its assigned label y to the supervised training dataset Y_{L} and removing the query node q* from unlabeled dataset U. Actions 202 to 212 form a single query iteration and are repeated a total of B times. For each query iteration, the latest version of updated features matrix X is applied.

At the conclusion of B query iterations, an enhanced features matrix X′ that includes an enhanced supervised training dataset Y′_{L} with B additional labelled nodes 102_{L} and a smaller unlabeled dataset U is output by learning module 106.

In example embodiments the enhanced features matrix X′ and the adjacency matrix A, which collectively form a graph that includes more labelled nodes than the original observed graph 100, are provided to prediction module 110. In example embodiments, prediction module 110 also includes a respective logistic regression algorithm having learnable regression weights W_{P} that can be trained to implement an inference function to predict labels for the remaining unlabeled nodes 102_{U}.

In at least some applications, the use of logistic regression as an inference mechanism as well as a probabilistic model are that the described graph processing system 101 does not rely on a validation set for optimizing hyper-parameters as required by typical GCNN solutions, rather, system 101 may only require a very limited initial training dataset for the active learning process performed by learning module 106. Additionally, in at least some examples system 101 may provide better classification accuracy for a very limited initial training dataset.

One possible application for graph processing system 101 is in the context of telecommunications network applications. Data from many telecommunications network applications are supported on graphs such as data from wireless cellular networks, Wi-Fi networks and fixed networks. Anomaly detection problem in general is an important task in all those scenario. The current solution relies on expert to manually label the anomaly components. An effective active learning approach such as that used by learning module 106 may be used to guide the expert to label the most informative nodes.

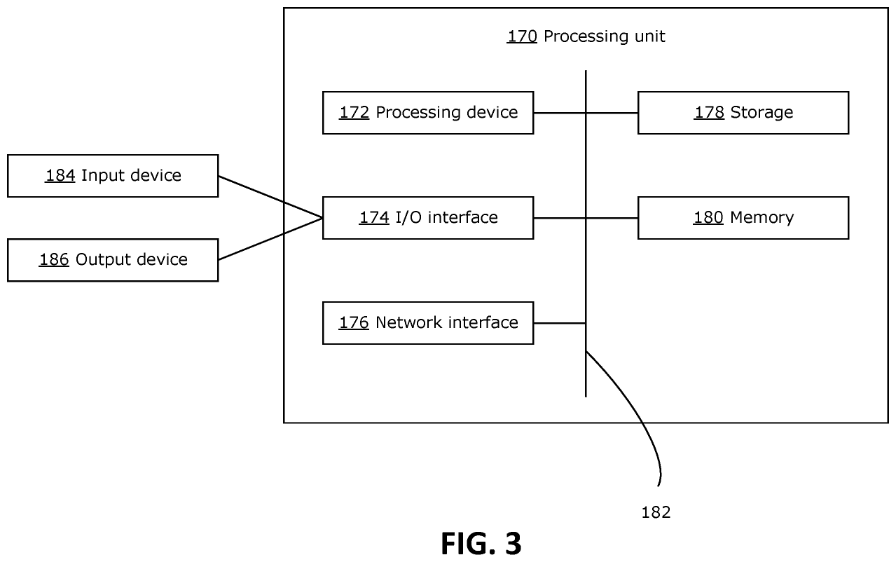

FIG. 3 is a block diagram of an example processing unit 170, which may be used to execute machine executable instructions of to implement one or both of learning module 106 and prediction module 110. Other processing units suitable for implementing embodiments described in the present disclosure may be used, which may include components different from those discussed below. Although FIG. 3 shows a single instance of each component, there may be multiple instances of each component in the processing unit 170.

The processing unit 170 may include one or more processing devices 172, such as a processor, a microprocessor, an application-specific integrated circuit (ASIC), a field-programmable gate array (FPGA), a dedicated logic circuitry, an artificial intelligence (AI) processing unit, or combinations thereof. The processing unit 170 may also include one or more input/output (I/O) interfaces 174, which may enable interfacing with one or more appropriate input devices 184 and/or output devices 186. The processing unit 170 may include one or more network interfaces 176 for wired or wireless communication with a network.

The processing unit 170 may also include one or more storage units 178, which may include a mass storage unit such as a solid state drive, a hard disk drive, a magnetic disk drive and/or an optical disk drive. The processing unit 170 may include one or more memories 180, which may include a volatile or non-volatile memory (e.g., a flash memory, a random access memory (RAM), and/or a read-only memory (ROM)). The memory(ies) 180 may store instructions for execution by the processing device(s) 172, such as to carry out examples described in the present disclosure. The memory(ies) 180 may include other software instructions, such as for implementing an operating system and other applications/functions.

There may be a bus 182 providing communication among components of the processing unit 170, including the processing device(s) 172, I/O interface(s) 174, network interface(s) 176, storage unit(s) 178 and/or memory(ies) 180. The bus 182 may be any suitable bus architecture including, for example, a memory bus, a peripheral bus or a video bus.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method for processing an attributed graph that comprises a training dataset of labelled nodes and unlabeled nodes, the method comprising:
selecting, using logistic regression, which candidate node from a plurality of possible candidate nodes included in the unlabeled dataset will minimize a risk if that candidate node is added to the training dataset;
obtaining a label for the selected candidate node from a classification resource; and
adding the selected candidate node and the obtained label to the training dataset as a labelled node to provide an enhanced training dataset.

2. The method of claim 1 wherein the selecting, obtaining and adding are repeated a predefined number of times to add a corresponding number of labelled candidate nodes to the training data set.

3. The method of claim 2 further comprising: learning, using the attributed graph including the enhanced training dataset, a prediction function to predict labels for the unlabeled nodes in the unlabeled dataset.

4. The method of claim 3 wherein the prediction function is a regression function learned using a respective logistic regression algorithm.

5. The method of claim 1 wherein selecting the candidate node comprises:
determining, for each of the plurality of possible candidate nodes, a respective risk value, the selected candidate node being the candidate node having the lowest respective risk value.

6. The method of claim 5 wherein determining the respective risk value for each of the possible candidate node comprises: for each candidate node candidate node, predicting for each possible label from a set of k candidate labels, the label distribution of the other possible candidate nodes if the candidate node is added to the training set with that label.

7. The method of claim 6 wherein predicting the label distribution in respect of the candidate node added to the training set with the label is performed by training a logistic regression algorithm to learn a respective regression function that outputs the predicted label distribution.

8. The method of claim 1 wherein obtaining the label for the selected candidate node comprises providing a label query for the selected candidate node to the classification resource, wherein the classification resource includes an interface for presenting information about the selected candidate node to, and receiving a labelling input, from a human.

9. The method of claim 1 wherein the obtaining the label for the selected candidate node comprises providing a label query for the selected candidate node to the classification resource, wherein the classification resource is an automated system.

10. The method of claim 1 wherein the logistic regression approximates a graphic convolution neural network process.

11. A system for processing an attributed graph that comprises a training dataset of labelled nodes and an unlabeled dataset of unlabeled nodes, the system comprising an active learning module that is configured to provide an enhanced training dataset by: selecting, using logistic regression, which candidate node from a plurality of possible candidate nodes included in the unlabeled dataset will minimize a risk if that candidate node is added to the training dataset; obtaining a label for the selected candidate node from a classification resource; and adding the selected candidate node and the obtained label to the training dataset as a labelled node to provide an enhanced training dataset.

13. The system of claim 1 wherein the active learning module is configured to repeat the selecting, obtaining and adding a predefined number of times to add a corresponding number of labelled candidate nodes to the training data set.

14. The system of claim 13, further including a prediction module that is configured to learn, using the attributed graph including the enhanced training dataset, a prediction function to predict labels for the unlabeled nodes in the unlabeled dataset.

15. The system of claim 14 wherein the prediction function is a regression function learned using a respective logistic regression algorithm.

16. The system of claim 11 wherein selecting the candidate node comprises:
determining, for each of the plurality of possible candidate nodes, a respective risk value, the selected candidate node being the candidate node having the lowest respective risk value.

17. The system of claim 16 wherein determining the respective risk value for each of the possible candidate node comprises: for each candidate node candidate node, predicting for each possible label from a set of k candidate labels, the label distribution of the other possible candidate nodes if the candidate node is added to the training set with that label.

18. The system of claim 17 wherein predicting the label distribution in respect of the candidate node added to the training set with the label is performed by training a logistic regression algorithm to learn a respective regression function that outputs the predicted label distribution.

19. The system of claim 18 wherein obtaining the label for the selected candidate node comprises providing a label query for the selected candidate node to the classification resource, wherein the classification resource includes an interface for presenting information about the selected candidate node to, and receiving a labelling input, from a human.

20. The system of claim 19 wherein the obtaining the label for the selected candidate node comprises providing a label query for the selected candidate node to the classification resource, wherein the classification resource is an automated system having labelling capabilities that are more trusted than those of the learning module.
